(19) United States
(12) Patent Application Publication
(10) Pub. No.: US 2026/0358279 A1
(43) Pub. Date: Nov. 12, 2026

(54) INFORMATION PROCESSING UNIT, INFORMATION PROCESSING METHOD, AND ANALYSIS APPARATUS USING THE SAME

(71) Applicant: Hitachi High-Tech Analysis Corporation, Tokyo (JP)

(72) Inventors: Naofumi HAMA, Tokyo (JP); Shinya NISHIMURA, Tokyo (JP); Eita SHIMODA, Tokyo (JP); Susumu ITO, Tokyo (JP); Hideya WADA, Tokyo (JP)

(21) Appl. No.: 19/654,550

(22) Filed: Apr. 22, 2026

(30) Foreign Application Priority Data
May 12, 2025 (JP) 2025-080080

(51) Int. Cl. G01N 25/48; G01N 25/02

(52) U.S. Cl. CPC G01N 25/4866; G01N 25/02

(57) ABSTRACT

An information processing unit that performs data analysis based on waveform data regarding a thermal characteristic includes: a processor that executes a computer program; a storage device that stores a plurality of parameter set candidates related to the computer program; a display device that displays information received from the computer program to a user; and an input device that receives, from the user, an input related to setting information regarding a parameter related to the computer program, in which the processor receives the waveform data, the display device displays a plurality of analysis results of the data analysis using, as parameter sets, a plurality of parameter set candidates stored in the storage device, the input device receives, from the user, a parameter set information input related to the setting information, and the processor specifies adopted parameter set information based on the parameter set information input.

### CROSS-REFERENCE TO RELATED APPLICATION

The present application claims priority from Japanese application JP2025-080080, filed on May. 12, 2025, the content of which is hereby incorporated by reference into this application.

### BACKGROUND OF THE INVENTION

### 1. Field of the Invention

The present disclosure relates to an information processing unit, an information processing method, and an analysis apparatus using the same.

### 2. Description of the Related Art

Hitherto, as a method of evaluating a temperature characteristic of a sample, a method called thermal analysis has been performed in which a sample is heated and thermal behavior (physical change) of a measurement sample associated with the temperature change is measured.

The thermal analysis is defined in JIS K 0129:2005 “General Rules for Thermal Analysis”, and all methods of measuring a physical property of a measurement sample when a temperature of a measurement target (measurement sample) is program-controlled are regarded as the thermal analysis. Commonly used thermal analysis includes five methods:
(1) differential thermal analysis (DTA) for detecting a temperature (temperature difference),
(2) differential scanning calorimetry (DSC) for detecting a heat flow difference,
(3) thermogravimetry (TG) for detecting a mass (weight change),
(4) thermomechanical analysis (TMA) for detecting a mechanical characteristic, and
(5) dynamic mechanical measurement (DMA).

The thermal analysis and the like have been known because it is important to know how a substance behaves in response to a temperature change at a site of material development or product inspection. Examples of such thermal analyses include a thermal analysis technology in which a controlled temperature change is applied to a substance, and how a physical quantity of the substance changes in response to the temperature change is evaluated. In general, values such as a heat flow, a mass, and an elastic modulus are measured as a function of temperature and time that can be regarded as substantially continuous values, and are recorded in the form of waveform data or the like which is a type of unstructured data.

In order to obtain a physical quantity related to a thermal characteristic of a material from the waveform data obtained in this manner, it is usually necessary to perform signal processing on the waveform data. For example, when a temperature difference occurs between a reference substance and a material to be measured, the temperature difference is acquired as a transition temperature at which the substance undergoes a phase transition. In addition, when a heat flow takes a peak shape near a transition temperature, the area by which the peak is shifted from a baseline is acquired as an enthalpy change amount of the substance before and after a phase transition. However, such signal processing often depends on the user’s knowledge of the substance and the thermal analysis, and thus, the difficulty of technology transfer due to high dependence on individual skills has been often regarded as a problem.

There has also been an attempt to reduce the dependence on individual skills and improve the throughput by achieving automation of such signal processing using machine learning. On the other hand, the signal processing varies depending on the purpose of thermal analysis or the like, such as whether one peak should be set targeted for enthalpy change amount acquisition processing. For each of such different use cases or purposes, it is usually difficult to collect sufficient training data for machine learning to achieve adequate accuracy.

A method of creating a specific machine learning model and finely adjusting a result analyzed by the machine learning model according to an analysis purpose is also conceivable. However, in actual analysis work, a series of materials that have similar compositions but are slightly different from each other are often analyzed collectively, and in such a case, it is inefficient to individually perform fine adjustment on the series of materials.

JP 2023-80556 A discloses a thermal analysis data processing apparatus capable of accurately detecting an inflection point temperature from thermal analysis data of various substances. The thermal analysis data processing apparatus described in JP 2023-80556 A includes: a condition setting unit that sets a detection condition for an inflection point temperature by performing machine learning using train data including known data, which is known thermal analysis data, and a ground-truth temperature, which is an inflection point temperature designated in advance in the known data; and a temperature detection unit that detects the inflection point temperature from thermal analysis data of a sample according to the detection condition.

In the technology disclosed in JP 2023-80556 A, detection of the inflection point temperature, which is one of physical quantities to be acquired by the thermal analysis, can be automated by machine learning.

### SUMMARY OF THE INVENTION

However, with the technology described in JP 2023-80556 A, other physical quantities cannot be acquired. Not limited to the thermal characteristic, an inflection point of waveform data in particular can be determined in principle based on a first-order derivative of a waveform regardless of a difference in use case or analysis purpose, and thus can be acquired relatively easily as the physical quantity. Therefore, there is a need for an apparatus capable of accurately acquiring the physical quantities according to the difference in use case, analysis purpose, or the like, which is also applicable to physical quantities that are more difficult to acquire, such as a change amount.

An object of the present disclosure is to provide a user-friendly information processing unit and method for obtaining a necessary physical quantity by using an analysis apparatus or an analytical apparatus.

In order to solve the above problem, an information processing unit according to one aspect of the present disclosure is an information processing unit that performs data analysis based on waveform data regarding a physical quantity, the information processing unit including: a processor that executes a computer program; a storage device that stores a plurality of parameter set candidates related to the computer program; a display device that displays information received from the computer program to a user; and an input device that receives, from the user, an input related to setting information regarding a parameter related to the computer program, in which the processor receives the waveform data regarding a physical quantity, the display device displays a plurality of analysis results of the data analysis using, as parameter sets, a plurality of parameter set candidates stored in the storage device, the input device receives, from the user, a parameter set information input related to the setting information, and the processor specifies adopted parameter set information based on the parameter set information input.

According to the present disclosure, a user can efficiently acquire a physical quantity used for analysis from waveform data.

### BRIEF DESCRIPTION OF THE DRAWINGS

FIG. 1 is a block diagram of an information processing unit of a first embodiment;

FIG. 2 is a block diagram illustrating a hardware configuration example of a computer;

FIG. 3 is an explanatory diagram illustrating an example of input waveform data according to the first embodiment;

FIG. 4 is a graph of the input waveform data;

FIG. 5 is an explanatory diagram illustrating an example of parameter set candidate data according to the first embodiment;

FIG. 6 is a flowchart illustrating processing of performing analysis trial of parameter adjustment data;

FIG. 7 is an explanatory diagram illustrating an example of a screen;

FIG. 8 is a block diagram of an information processing unit of a second embodiment;

FIG. 9 is a flowchart illustrating an example of adopted parameter analysis;

FIG. 10 is a block diagram of an information processing unit according to a third embodiment;

FIG. 11 is an explanatory diagram illustrating an example of thermal analysis annotation data;

FIG. 12 is a flowchart illustrating processing of performing analysis trial of parameter adjustment data; and

FIG. 13 is an explanatory diagram illustrating an example of a screen.

### DESCRIPTION OF THE PREFERRED EMBODIMENTS

Hereinafter, embodiments will be described with reference to the drawings.

An analysis apparatus according to the present invention includes: a sample; a heating furnace that heats the sample; a heating furnace controller that controls a temperature of the heating furnace according to a temperature profile set by an operator; a physical quantity sensor that measures temperatures of a reference sample holder and a measurement sample holder and a differential scanning calorimetry (DSC) signal; a measurement data acquirer that samples the temperatures and the DSC signal input from the physical quantity sensor and imports the temperatures and the DSC signal as waveform data; and a waveform display that displays the waveform data on a display medium such as a display or a printer.

Hereinafter, embodiments will be described with reference to the drawings. The present embodiment discloses a technology for acquiring a physical quantity from waveform data regarding similar thermal characteristics. As an example, the present embodiment discloses a technology for efficiently selecting an analysis algorithm and a model parameter for acquiring a physical quantity from waveform data regarding a series of thermal characteristics similar to each other. That is, the present embodiment provides an information processing unit for efficiently selecting an analysis algorithm and a model parameter for acquiring a physical quantity according to a difference in use case, analysis purpose, or the like from waveform data regarding a series of thermal characteristics similar to each other.

In the information processing unit of the present embodiment, a plurality of candidates for a parameter set to be used for data analysis are stored in a storage device, a processor acquires a plurality of thermal analysis results by data analysis using, as the parameter sets, the plurality of parameter set candidates stored in the storage device, a display device displays the plurality of thermal analysis results, an input device receives an input related to the parameter set candidates, and the processor specifies parameter set information based on the input.

### First Embodiment

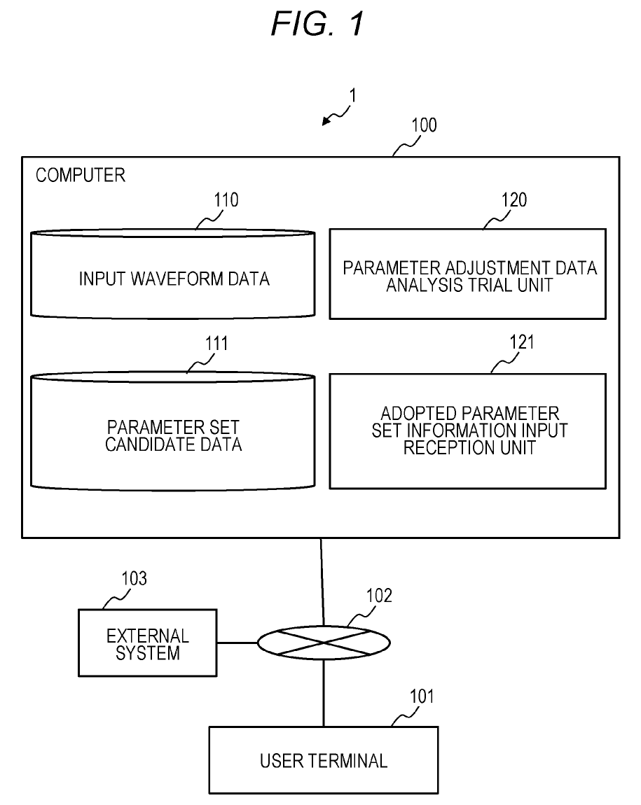

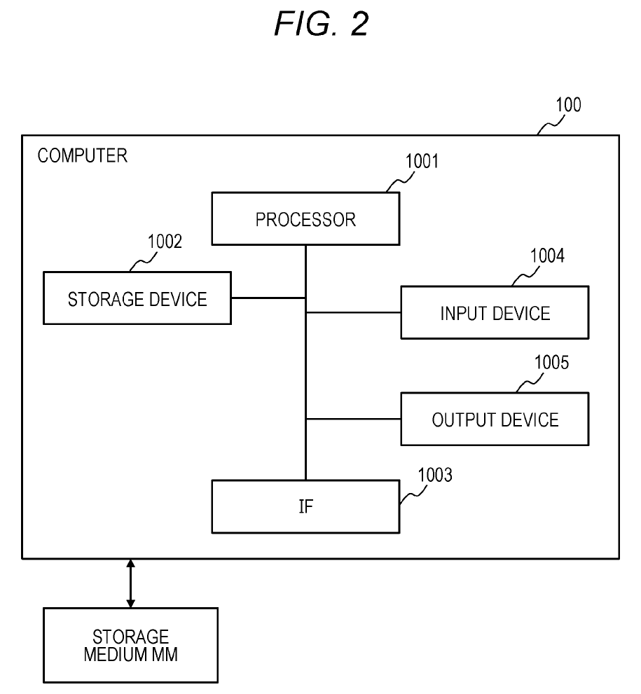

FIG. 1 is a block diagram of an information processing unit 1 of a first embodiment. FIG. 2 is a block diagram illustrating a hardware configuration of a computer 100 included in the information processing unit 1.

Referring to FIG. 1, the information processing unit 1 includes a computer 100 and a user terminal 101. The computer 100 and the user terminal 101 are connected to a communication network 102. The communication network 102 is a facility that enables transmission and reception of data through a wired or wireless line. Furthermore, the computer 100 and the user terminal 101 can also be connected to an external system 103 via the communication network 102. Examples of the external system 103 include a thermal measurement device and a file server.

The computer 100 can access input waveform data 110 and parameter set candidate data 111. The computer 100 includes a parameter adjustment data analysis trial unit 120 that performs analysis trial of parameter adjustment data, and an adopted parameter set information input reception unit 121 that receives an input of adopted parameter set information.

Referring to FIG. 2, the computer 100 includes, for example, a processor 1001, a storage device 1002, a network interface 1003, an input device 1004, and an output device 1005.

The storage device 1002 stores data in a writable and readable form. Data used for computation processing or a result of the computation processing is stored in the storage device 1002. The illustrated storage device 1002 may include a main storage device and an auxiliary storage device.

The processor 1001 executes a predetermined computer program (not illustrated). The parameter adjustment data analysis trial unit 120 and the adopted parameter set information input reception unit 121 in the computer 100 are implemented by the processor 1001 executing a computer program. The processor 1001 is not limited to a central processing unit (CPU), and may include a graphics processing unit (GPU), an application specific integrated circuit (ASIC), or the like.

The network interface 1003 is a device that transmits and receives data to and from other devices 102 and 103 via the communication network 102. The network interface 1003 can transmit processing result data of the processor 1001 to another device such as the user terminal 102 via the communication network 102. The network interface 1003 can receive data to be provided for processing in the processor 1001 from another device such as the user terminal 102 via the communication network 102.

The input device 1004 is a device for a user to input information to the computer 100. Examples of the input device 1004 include a keyboard, a pointing device, and a microphone.

The output device 1005 is a device that provides information from the computer 100 to the user. Examples of the output device 1005 include a monitor display, a printer, and a speaker. In order to exchange information with the user, the computer 100 may use a technology known as virtual reality (VR), augmented reality (AR), mixed reality (MR), or extended reality (XR).

The description will return to FIG. 1. The computer 100 can access the input waveform data 110.

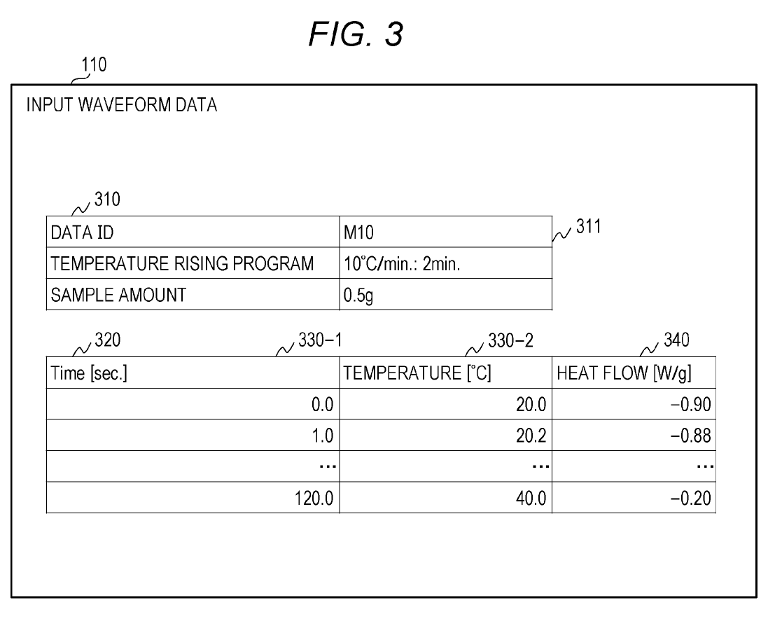

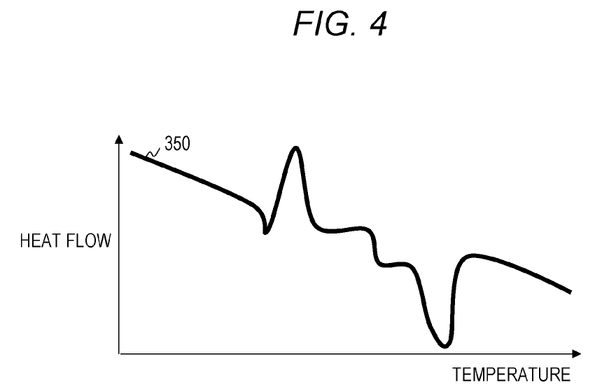

FIGS. 3 and 4 illustrate examples of the input waveform data 110 according to the present embodiment. FIG. 3 illustrates a table of measured values of the input waveform data 110. FIG. 4 is a graph illustrating the input waveform data.

The input waveform data 110 related to a thermal characteristic includes, for example, a feature 310 that describes a feature of an input waveform and a waveform descriptor 320 that describes a measured value for each time and temperature.

An input waveform data ID 311, which is an individual identification number for the input waveform data 110, is attached to the feature 310. The feature 310 can include information used for analysis of the input waveform data, such as a temperature change computer program (indicated as a “temperature rising program” in FIG. 3) or a sample amount for performing unit conversion related to a numerical value stored in the waveform descriptor 320 or limitation of a measurement target.

In the waveform descriptor 320, for example, a time 330-1 and a temperature 330-2 are stored, and a measured value 340 such as a heat flow at each time point is also stored. The time 330-1 and the temperature 330-2 are recorded at intervals such that recorded values can be regarded as substantially continuous values, and when the corresponding measured values 340 are plotted, a continuous waveform graph 350 as illustrated in FIG. 4 is obtained. Hereinafter, both the time 330-1 and the temperature 330-2 may be referred to as time. A first-order derivative or a higher-order derivative of the measured value 340 for the time 330-1 or the temperature 330-2 can be substantially obtained from difference values related to the time 330-1 or the temperature 330-2, and thus, derivatives and differences are not distinguished from each other in the following description. A point at which absolute values of the input waveform, the first-order derivative, and the higher-order derivative of the input waveform take extremely large values corresponds to a phase transition point of a substance, and obtaining a peak area of a waveform around the point corresponds to calculation of a physical quantity as a purpose of thermal analysis.

Returning to FIG. 1, the computer 100 can access the parameter set candidate data 111.

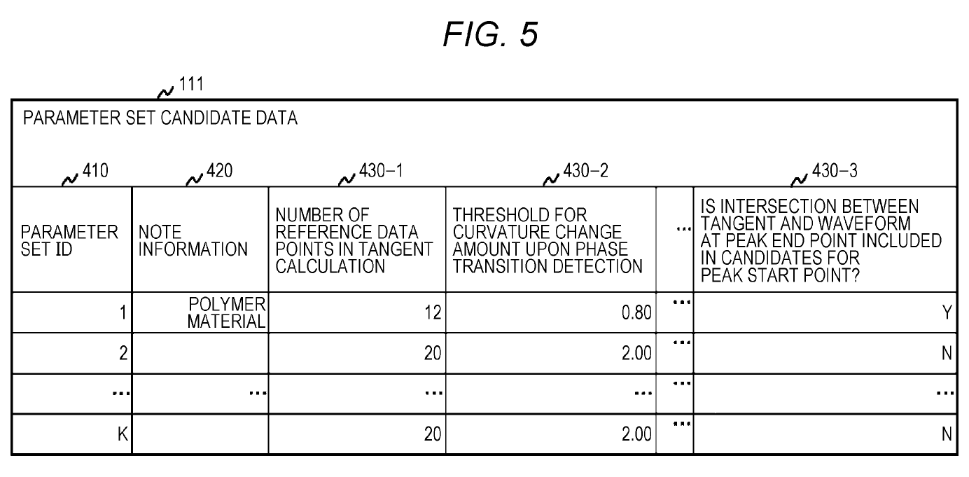

FIG. 5 illustrates an example of the parameter set candidate data 111. A parameter set ID 410 for each parameter set candidate is attached to the parameter set candidate data 111. The parameter set candidate data 111 includes parameter set information 430 that needs to be set when an algorithm related to the thermal analysis performed by the parameter adjustment data analysis trial unit 120 is designated or the thermal analysis is performed.

Depending on a set value of the parameter set information 430, an area surrounded by a line segment connecting a start time and an end time and a waveform may be calculated as the physical quantity for a phase transition in which an intersection between the waveform and a tangent of the waveform at the end time of the phase transition is set as the start time of the phase transition, as the algorithm related to the thermal analysis. Depending on the set value of the parameter set information 430, a threshold may be set as to whether or not a curvature value of the waveform has changed during a predetermined time section, and occurrence of the phase transition may be detected in a case where the threshold is exceeded. Depending on the set value of the parameter set information 430, when a line segment connecting a value on the waveform at the obtained start time of the phase transition and a value at the obtained end time intersects with the waveform, a search may be performed by a known method in which the obtained start time and the obtained end time are set as initial values so as not to cause the intersection.

The parameter set candidate data 111 may include note information 420 such as history information indicating what material each parameter set candidate was used for past thermal analysis.

Returning to FIG. 1, the computer 100 includes the parameter adjustment data analysis trial unit 120. The parameter adjustment data analysis trial unit 120 processes the parameter adjustment data selected from the input waveform data 110 by using computation processing information for performing data analysis related to the thermal analysis, which is created from the parameter set candidate data 111, and acquires a result thereof. Hereinafter, the parameter adjustment data analysis trial unit 120 may be abbreviated as an “analysis trial unit 120”.

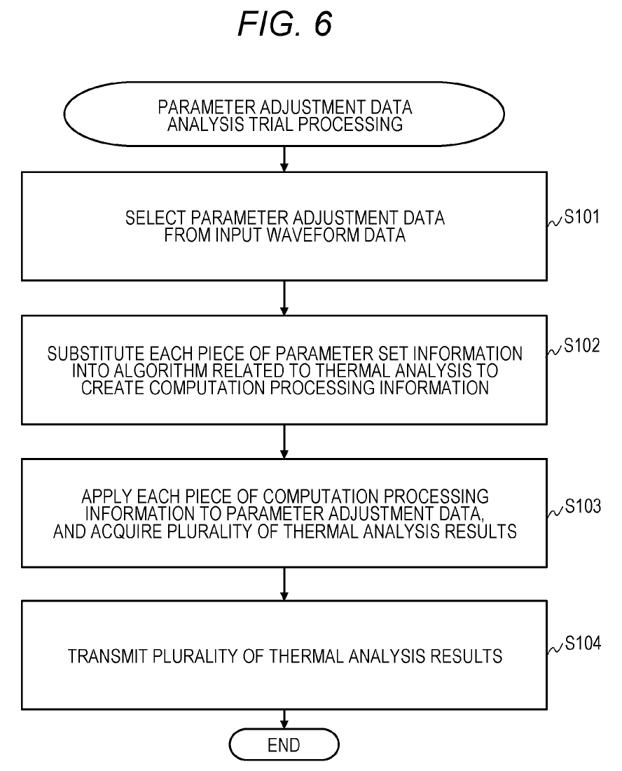

FIG. 6 is a flowchart illustrating an example of parameter adjustment data analysis trial processing in the analysis trial unit 120.

The analysis trial unit 120 selects one or more pieces of parameter adjustment data for performing parameter adjustment data analysis from the input waveform data 110 (S101). The analysis trial unit 120 may perform selection based on a value recorded in the feature 310 related to the input waveform data 110, may perform selection according to an operation of the user through the input device 1004, or may perform selection based on a random number generated by the processor 1001 or the like.

The analysis trial unit 120 substitutes the parameter set information 430 recorded in each of the pieces of parameter set candidate data 111 into the algorithm related to the thermal analysis to create the computation processing information for performing data analysis (S102). The analysis trial unit 120 does not necessarily need to create the computation processing information for all the pieces of parameter set candidate data 111.

The analysis trial unit 120 applies the computation processing information to the parameter adjustment data to perform the thermal analysis, and acquires a plurality of thermal analysis results according to the number of pieces of computation processing information created in step S102 (S103).

The analysis trial unit 120 transmits the plurality of thermal analysis results acquired in step S103 to the adopted parameter set information input reception unit 121, and ends the processing (S104). The transmitted thermal analysis results may include intermediate computation information used to calculate the physical quantity.

Returning to FIG. 1, the computer 100 includes the adopted parameter set information input reception unit 121. The adopted parameter set information input reception unit 121 displays, on the user terminal 101, the plurality of thermal analysis results transmitted from the analysis trial unit 120 in order to receive, from the user, an input for the information regarding an adopted parameter set. Hereinafter, the adopted parameter set information input reception unit 121 may be abbreviated as an “input reception unit 121”.

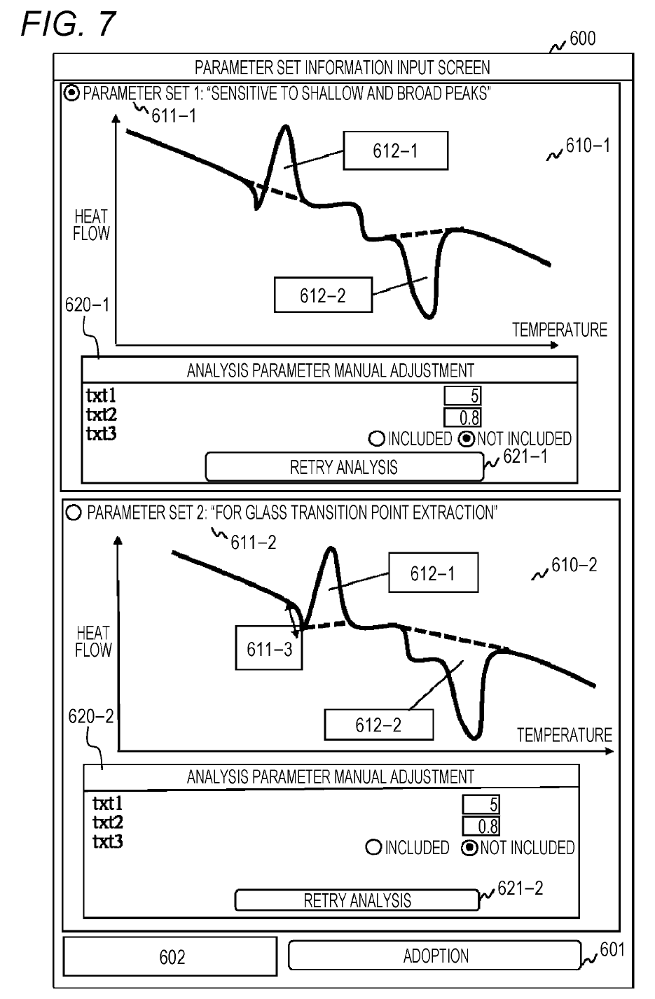

FIG. 7 illustrates an example of a screen 600 generated by the input reception unit 121. The parameter set information input screen 600 is provided to the user in order to receive, from the user, an input for the information regarding the adopted parameter set. Hereinafter, the adopted parameter set information input reception screen 600 may be abbreviated as an input reception screen 600.

The input reception screen 600 is displayed on the user terminal 101 and receives, from the user, an input for the adopted parameter set.

As an example, the input reception screen 600 can include a plurality of thermal analysis trial result display fields 610 and analysis parameter manual adjustment sections 620.

The thermal analysis trial result display field 610 is a field for displaying the plurality of thermal analysis results transmitted from the analysis trial unit 120. The thermal analysis trial result display field 610 can display each thermal analysis result transmitted from the analysis trial unit 120 and the parameter adjustment data corresponding to each thermal analysis. Hereinafter, the thermal analysis trial result display field 610 may be abbreviated as a result display unit 610.

The result display field 610 may include a field 611 for displaying the parameter set information. The parameter set information display field 611 can display the parameter set information 430 substituted when the corresponding computation processing information is created, and the parameter set ID 410 or the note information 420 stored in association with the parameter set information 430.

The result display field 610 may include the physical quantity acquired as a thermal analysis trial result and a physical quantity display field 612 that displays the intermediate computation information used to calculate the thermal analysis trial result. In the result display field 610, for example, based on which portion of the input waveform a physical quantity that is related to a local portion of the waveform, such as the physical quantity associated with the phase transition point, among the physical quantities acquired as the thermal analysis trial results has been calculated can be displayed in association with the parameter adjustment data by, for example, coloring a quadrature portion of the peak.

In the analysis parameter manual adjustment section 620, the user can adjust a value of the parameter set information 430. When the user presses an analysis retrying button 621 after performing the adjustment, adjusted parameter set information is transmitted to the analysis trial unit 120. The analysis trial unit 120 retries the thermal analysis according to the computation processing information into which the adjusted parameter set information is substituted, and displays a result thereof in the result display field 610.

The user performs adjustment by the analysis parameter manual adjustment section 620 by referring to the result display field 610, selects the adopted parameter set information which is a parameter set to be used for analysis of the input waveform data 110, and presses an adoption confirmation button 601. As a result, the adopted parameter set information is stored in the storage device 1002.

When the user presses the adoption confirmation button 601, the user may enter a reason why the adopted parameter set information is selected in an adoption basis note field 602. The entered item can be stored together with the adopted parameter set information and can be referred to by the user later. Further, the note information 420 stored in association with the parameter set information 430 can be updated based on the entered item.

Hereinafter, an example of contents simplified and displayed in FIG. 7 will be described below.
Reference sign 612-1
   “Upward peak
      Start temperature: xx °C
      End temperature: yy °C
      Peak top temperature: zz °C
      Enthalpy change amount: -aa (J/g)”
Reference sign 612-2
   “Downward peak
   Start temperature: xxx °C
   End temperature: yyy °C
   Peak top temperature: zzz °C
   Enthalpy change amount: aaa (J/g)”
Reference sign 612-3
   “Glass transition point
      Start temperature: xx °C
      End temperature: yy °C
      Tangential change amount: -aa (J/g·°C)"
Reference sign txt1
   “Number of reference data points upon tangent calculation”
Reference sign txt2
   “Threshold for curvature change amount upon phase transition detection”
Reference sign txt3
   “Is intersection between tangent and waveform at peak end point included in candidates for peak start point?”
Reference signs 621-1 and 621-2
   “Retrying analysis with adjusted parameter”
Reference sign 601
   “Adopting selected parameter set”
Reference sign 602
   “Note field indicating basis of adoption"

A graphical user interface (GUI) illustrated in the screen 600 of FIG. 7 is an example, and is not limited thereto. In addition, the user does not necessarily need to set all setting items, and automatic setting by an appropriate method is not precluded.

As described above, in the information processing unit 1 of the first embodiment, when performing the thermal analysis of a plurality of pieces of input waveform data 110, the user can acquire the parameter set necessary for the analysis only by selecting and adjusting a small number of pieces of parameter adjustment data while referring to the analysis result. In particular, the physical quantity and the intermediate computation information of the analysis result are in a format that can be referred to by the user based on knowledge of the target material and the thermal analysis, even if the user is not necessarily familiar with a calculation algorithm for the analysis. Therefore, even a user who is not familiar with the calculation algorithm of the analysis can efficiently select an analysis algorithm or a model parameter for efficiently acquiring the physical quantity according to a difference in use case or analysis purpose.

### Second Embodiment

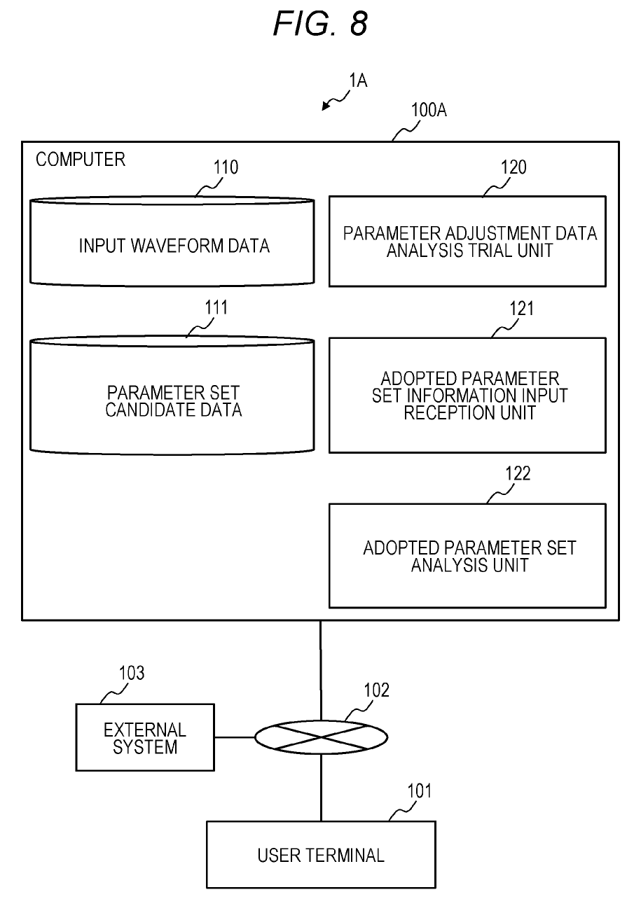

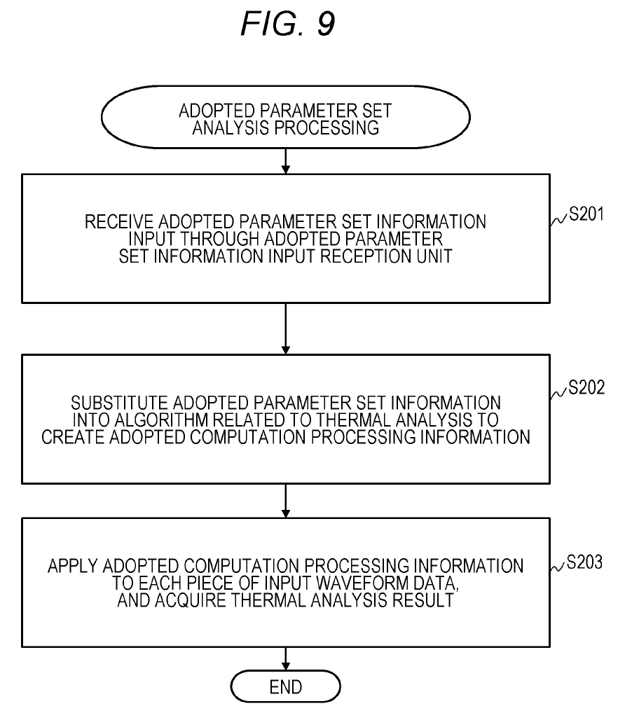

A second embodiment will be described with reference to FIGS. 8 and 9. In the following embodiments including the second embodiment, differences from the first embodiment will be mainly described. In the second embodiment, an example of an information processing unit 1A for performing thermal analysis on a plurality of pieces of input waveform data by using computation processing information into which adopted parameter set information acquired in the first embodiment is substituted, and acquiring a result thereof will be described.

FIG. 8 is a block diagram of the information processing unit 1A of the second embodiment. A computer 100A of the second embodiment includes an adopted parameter set analysis unit 122 in addition to an analysis trial unit 120B and an input reception unit 121.

FIG. 9 is a flowchart illustrating an example of adopted parameter set analysis processing by the adopted parameter set analysis unit 122. In the second embodiment, the adopted parameter set information confirmed by a user on an input reception screen 600 is transmitted to the adopted parameter set analysis unit 122. When the parameter set information adopted by the user is received, the adopted parameter set analysis unit 122 starts processing (step S201). Alternatively, the adopted parameter set analysis unit 122 reads the adopted parameter set information stored in a storage device 1002 and starts the processing.

The adopted parameter set analysis unit 122 substitutes the adopted parameter set information into an algorithm related to the thermal analysis to create adopted computation processing information (step S202).

The adopted parameter set analysis unit 122 applies the adopted computation processing information to input waveform data 110 to perform the thermal analysis, acquires a result thereof, and ends the processing (step S203). The acquired result may be stored in the storage device 1002 or displayed on a user terminal 101.

It is sufficient if an analysis algorithm used when an analysis trial unit 120 applies the computation processing information to parameter adjustment data and performs the thermal analysis is similar to an analysis algorithm used when the adopted parameter set analysis unit 122 applies the adopted computation processing information to the input waveform data 110 and performs the thermal analysis to such an extent that sufficient information for specifying an adopted parameter set can be provided, and the analysis algorithms do not have to be completely the same as each other.

In particular, a trial-and-error process for parameter adjustment and actual analysis for obtaining a physical quantity with high accuracy from the input waveform data 110 can be effectively performed by using an analysis algorithm with higher speed and lower accuracy for the former analysis, performing a retry using an input to an analysis parameter manual adjustment section 620 and displaying a result thereof at high speed, and adopting an algorithm with higher accuracy and lower speed than the former analysis for the latter analysis using the adopted parameter set whose adoption has been confirmed.

According to the second embodiment configured as described above, when the thermal analysis is performed on the plurality of pieces of input waveform data 110, a parameter set necessary for the analysis can be acquired only by selecting and adjusting a small number of pieces of parameter adjustment data while referring to the analysis result, and the analysis result related to the thermal analysis can be acquired using the adopted computation processing information created based on the parameter set.

### Third Embodiment

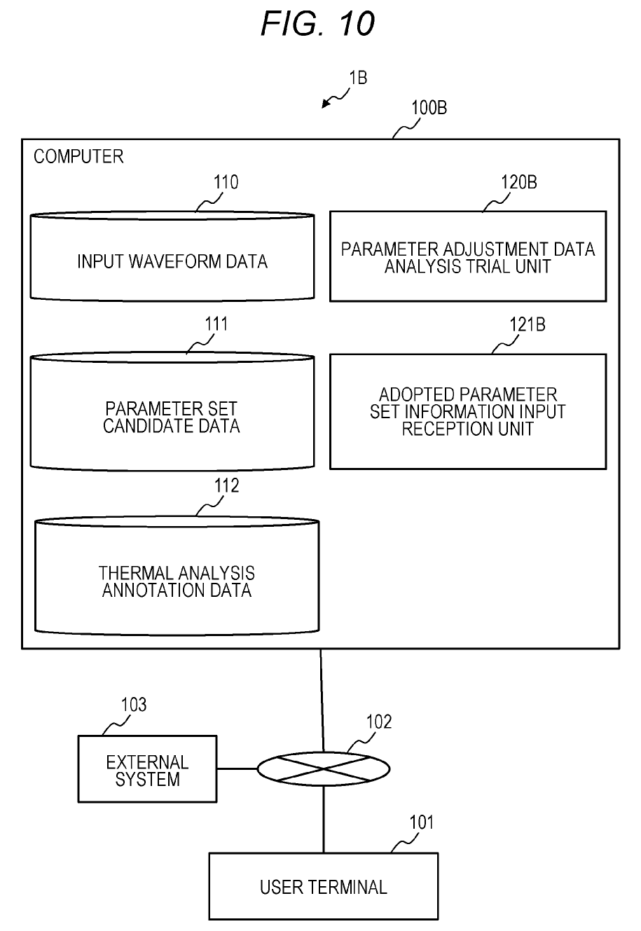

An information processing unit 1B according to a third embodiment will be described with reference to FIGS. 10 to 13. In the third embodiment, a configuration applicable in a case where annotation data related to a result of thermal analysis, which is generated by a user, is obtained for a small amount of parameter adjustment data when an input for information regarding an adopted parameter set is received from the user in the first embodiment will be described. The information processing unit 1B of the third embodiment provides a difference between the annotation data and a plurality of thermal analysis results transmitted from an analysis trial unit 120B to the user, and provides information that is more easily perceived by the user in selecting adopted parameter set information.

FIG. 10 is a block diagram of the information processing unit 1B of the third embodiment. In the third embodiment, a computer 100B is a computer that can access thermal analysis annotation data 112 in addition to input waveform data 110 and parameter set candidate data 111.

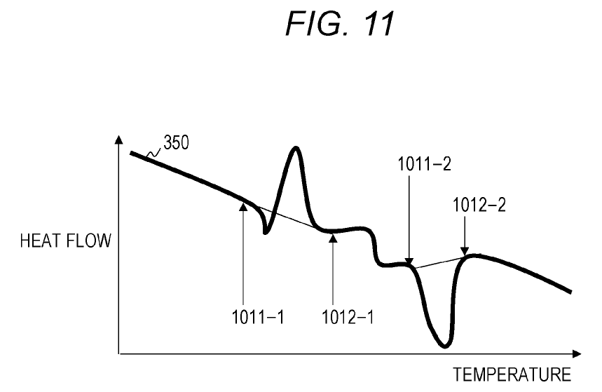

FIG. 11 illustrates an example of the thermal analysis annotation data 112 according to the third embodiment. In the thermal analysis annotation data 112, a phase transition start time 1011 and a phase transition end time 1012 can be recorded for a waveform graph 350 related to a part of or the entirety of the input waveform data 110. The phase transition start time 1011 is a time for determining from where a peak to be extracted in thermal analysis is regarded as a phase transition point for analysis. The phase transition end time 1012 is an end time for determining to where the peak to be extracted in thermal analysis is regarded as the phase transition point for analysis.

Here, for convenience of description, a physical quantity to be analyzed can be specified by times before and after a phase transition, but a physical phenomenon to be analyzed by the thermal analysis is not limited to the phase transition. Even in a case where a portion having a peak shape as a waveform shape is not to be extracted according to knowledge of a target material or an analysis purpose, it is possible to reflect the analysis purpose even if the portion is obviously not included in the thermal analysis annotation data 112.

Returning to FIG. 10, the computer 100B includes the analysis trial unit 120B. The analysis trial unit 120B according to the third embodiment processes the parameter adjustment data selected from the input waveform data 110 by using computation processing information for performing data analysis related to the thermal analysis, which is created from the parameter set candidate data 111, and acquires a result thereof. The analysis trial unit 120B compares the thermal analysis annotation data 112 and the physical quantity calculated using the thermal analysis annotation data 112 for the result, and creates difference information.

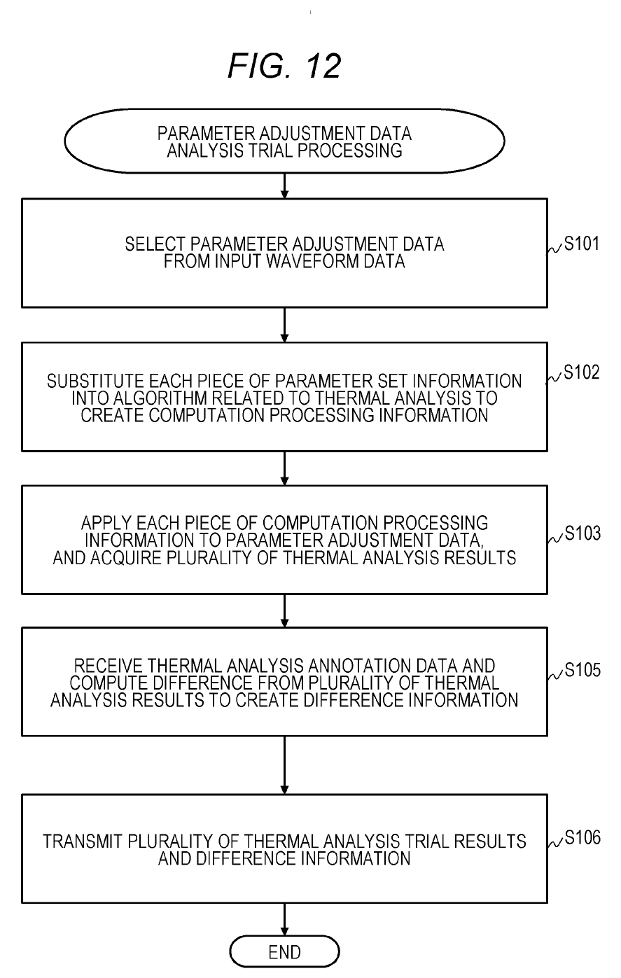

FIG. 12 is a flowchart illustrating an example of parameter adjustment data analysis trial processing in the analysis trial unit 120B. The analysis trial unit 120B performs processing on the parameter adjustment data selected from the input waveform data 110 by using the computation processing information for performing the data analysis related to the thermal analysis, which is created from the parameter set candidate data 111, in the same processing as steps S101, S102, and S103 in the analysis trial unit 120 according to the first embodiment, and acquires a result thereof.

When the thermal analysis annotation data 112 is received, the analysis trial unit 120B creates, for the parameter adjustment data selected from the input waveform data 110, the difference information between the thermal analysis annotation data 112 and intermediate computation information at the time of processing using the computation processing information for performing the data analysis related to the thermal analysis, which is created from the parameter set candidate data 111.

The analysis trial unit 120B calculates the physical quantity obtained by the data analysis related to the thermal analysis in a case where the thermal analysis annotation data 112 is used as the intermediate computation information, and creates the difference information from a result of processing based on the computation processing information for performing the data analysis related to the thermal analysis, which is created from the parameter set candidate data 111 (S105).

The difference information is not limited to a value simply obtained by addition, subtraction, multiplication, and division between numerical values, and includes, for example, a case of storing a flag indicating non-correspondence in a case where the phase transition point that is not detected in the intermediate computation information is assigned to the thermal analysis annotation data 112. For association between the intermediate computation information for creating the difference information and the thermal analysis annotation data 112, a known matching technology can be applied between times of the phase transition points to be extracted and the like.

The analysis trial unit 120B transmits a result of processing the parameter adjustment data based on the computation processing information and the created difference information to an input reception unit 121B, and ends the processing (S106).

Returning to FIG. 10, the computer 100B includes the input reception unit 121B. The input reception unit 121B according to the third embodiment displays, on a user terminal 101, the plurality of thermal analysis results and the difference information transmitted from the analysis trial unit 120B in order to receive, from a user, an input for the information regarding the adopted parameter set.

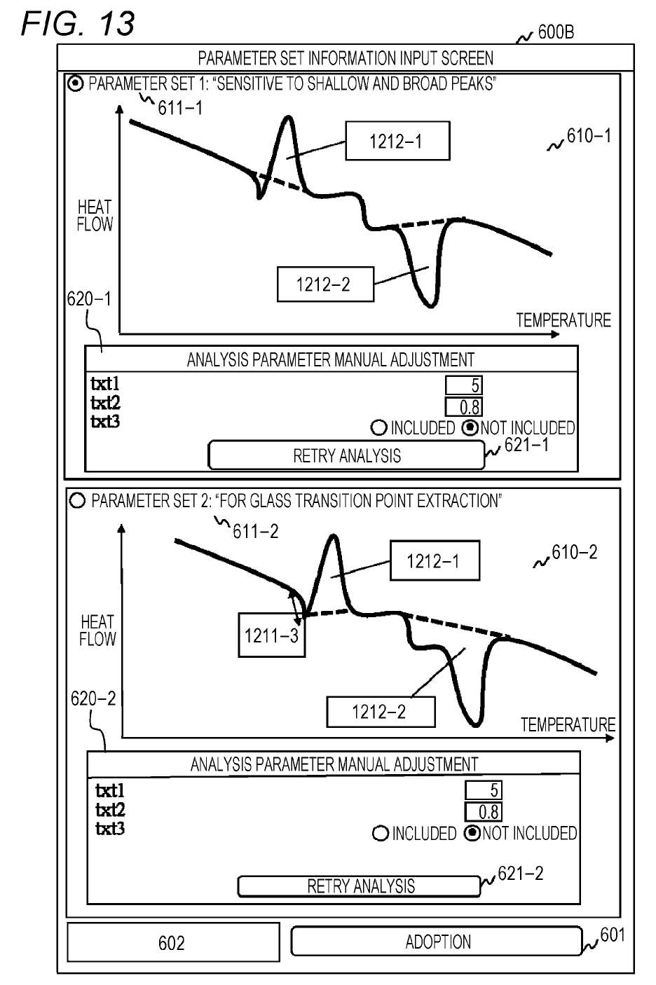

FIG. 13 illustrates an example of a screen 600B for receiving, from the user, the input for the information regarding the adopted parameter set, which is generated by the input reception unit 121B according to the third embodiment. The input reception screen 600B is displayed on the user terminal 101, and receives, from the user, an input for the adopted parameter set.

As an example, the input reception screen 600B includes a result display field 610 and an analysis parameter manual adjustment section 620. The result display field 610 according to the third embodiment can include, in addition to a parameter set information display field 611, a physical quantity display field 1212 that displays the physical quantity acquired as a thermal analysis trial result, the intermediate computation information used for computation of the thermal analysis trial result, and the difference information. The difference information can include a difference between a phase transition point start time and a phase transition point end time, a difference in physical quantity acquired from the corresponding phase transition point, and the like. It is also possible to display the difference information in a format that is more easily perceived by the user by performing coloring or the like according to a magnitude of the difference.

The computer 100B can aggregate the acquired physical quantity and the difference information of the intermediate computation information as numerical values that can be compared with each other by a known method such as setting of appropriate weighting in advance, and reflect the numerical values in display in the result display field 610 as scores for corresponding parameter set candidates. For example, the order of the parameter set candidates displayed in the result display field 610 can be changed to an ascending order or a descending order of the scores. For example, a threshold related to the score may be set, and parameter set candidates that do not exceed the threshold are not displayed.

Hereinafter, an example of contents simplified and displayed in FIG. 13 will be described below.
Reference sign 1212-1
   “Upward peak
      Start temperature: xx °C (+5 °C)
      End temperature: yy °C (-7 °C)
      Peak top temperature: zz °C
      Enthalpy change amount: -aa (J/g) (+5%)”
Reference sign 1212-2
   “Downward peak
      Start temperature: xxx °C (+12 °C)
      End temperature: yyy °C (-1 °C)
      Peak top temperature: zzz °C
      Enthalpy change amount: aaa (J/g) (-5%)”
Reference sign 1212-3
   "Glass transition point
      Start temperature: xx °C (no correspondence information)
      End temperature: yy °C (no correspondence information)
      Tangential change amount: -aa (J/g· °C) (no correspondence information)”

According to the third embodiment configured as described above, when selecting the adopted parameter set information, the user can refer to the difference information obtained by comparison with the annotation data related to the thermal analysis result attached to a small amount of parameter adjustment data. The user can easily select and adjust the adopted parameter set information more appropriately, and usability for the user is further improved.

Note that the present invention is not limited to the above-described embodiments and includes various modified examples and equivalent configurations within the scope of the appended claims. For example, the above-described embodiments have been described in detail in order to explain the present invention in an easy-to-understand manner, and the present invention is not necessarily limited to those having all the configurations described. Further, a part of the configuration of one embodiment may be replaced with the configuration of another embodiment. In addition, the configuration of another embodiment may be added to the configuration of one embodiment. In addition, a part of the configuration of each embodiment may be added with another configuration, may be deleted, or may be replaced with another configuration.

A part of, or the entirety of the respective configurations, functions, processing units, processing means, and the like described above may be implemented by hardware, for example, may be designed as an integrated circuit, or may be implemented by software for a processor interpreting and executing computer programs for implementing the respective functions.

Information such as a computer program, a table, and a file for implementing each function can be stored in a storage device such as a memory, a hard disk, and a solid state drive (SSD), or a recording medium such as an integrated circuit (IC) card, an SD card, or a digital versatile disc (DVD).

The control lines and information lines indicate those considered necessary for explanation, and do not necessarily indicate all the control lines and information lines necessary for implementation. In actual implementation, it may be considered that almost all the configurations are interconnected.

The present disclosure includes the invention having the following configuration.

Supplementary Note 1 An information processing unit that performs data analysis based on waveform data regarding a thermal characteristic, the information processing unit including:
a processor that executes a computer program;
a storage device that stores a plurality of parameter set candidates related to the computer program;
a display device that displays information received from the computer program to a user; and
an input device that receives, from the user, an input related to setting information regarding a parameter related to the computer program, in which
the processor receives the waveform data regarding the thermal characteristic,
the display device displays a plurality of thermal analysis results of the data analysis using, as parameter sets, a plurality of parameter set candidates stored in the storage device,
the input device receives, from the user, a parameter set information input related to the setting information, and
the processor specifies adopted parameter set information based on the parameter set information input.

Supplementary Note 2 The information processing unit according to Supplementary Note 1, in which the processor performs the data analysis based on the waveform data regarding the thermal characteristic by using the adopted parameter set information.

Supplementary Note 3 The information processing unit according to Supplementary Note 2, in which the waveform data regarding the thermal characteristic is differential scanning calorimetry (DSC) data of thermal analysis.

Supplementary Note 4 The information processing unit according to Supplementary Note 3, in which the data analysis based on the waveform data regarding the thermal characteristic is thermal analysis of a polymer material.

Supplementary Note 5 The information processing unit according to Supplementary Note 3, in which the data analysis based on the waveform data regarding the thermal characteristic is thermal analysis performed when a physical quantity related to a phase transition of a material is acquired.

Supplementary Note 6 The information processing unit according to Supplementary Note 5, in which the data analysis based on the waveform data regarding the thermal characteristic is thermal analysis performed by specifying a start time or a start temperature of the phase transition of a material and an end time or an end temperature of the phase transition of the material.

Supplementary Note 7 The information processing unit according to Supplementary Note 6, in which the parameter set candidates include a setting item as to whether or not to specify the start time or the start temperature of the phase transition of the material from an intersection between the waveform data and a tangent of the waveform data at the end time or the end temperature of the phase transition of the material.

Supplementary Note 8 The information processing unit according to Supplementary Note 6, in which the parameter set candidates include a threshold for a change amount of a curvature value of a waveform during a predetermined time section, and in a case where the threshold is exceeded, occurrence of the phase transition is detected by the data analysis based on the waveform data regarding the thermal characteristic using the adopted parameter set information.

Supplementary Note 9 The information processing unit according to Supplementary Note 6, in which the parameter set candidates include a setting item as to whether or not to calculate the start time or the start temperature of the phase transition of the material or the end time or the end temperature of the phase transition of the material by a search using the calculated start time or start temperature and the calculated end time or end temperature as initial values so as not to cause an intersection when a line segment connecting a value at the calculated start time or start temperature and a value at the calculated end time or end temperature of the phase transition of the material for the waveform data intersects the waveform data.

Supplementary Note 10 The information processing unit according to Supplementary Note 2, in which the parameter set information input from the user is an input of information including at least one of information selected from the plurality of parameter set candidates and information for individually changing a value set in the parameter set candidate.

Supplementary Note 11 The information processing unit according to Supplementary Note 2, in which the data analysis using the plurality of parameter set candidates stored in the storage device as the parameter sets and the data analysis based on the waveform data regarding the thermal characteristic using the adopted parameter set information are separate data analyses having different execution speeds.

Supplementary Note 12 An information processing method for causing an information processing unit that performs data analysis based on waveform data regarding a thermal characteristic to perform the data analysis, the information processing unit including a processor that executes a computer program, a storage device that stores a plurality of parameter set candidates related to the computer program, a display device that displays information received from the computer program to a user, and an input device that receives, from the user, an input for setting information regarding a parameter related to the computer program, the information processing method including:
receiving the waveform data regarding the thermal characteristic;
displaying, on the display device, a plurality of thermal analysis results of the data analysis using, as parameter sets, a plurality of parameter set candidates stored in the storage device;
receiving, by the input device, a parameter set information input related to the setting information from the user; and
specifying adopted parameter set information based on the parameter set information input.

Note that the present invention is not limited to the above embodiments. In the above embodiments, the description has been given using waveform data of the differential scanning calorimetry (DSC), but the present invention can also be applied to differential thermal analysis (DTA), differential scanning calorimetry (DSC), thermogravimetry (TG), thermomechanical analysis (TMA), and dynamic mechanical measurement (DMA), which are thermal analysis methods using waveform data regarding a thermal characteristic.

Furthermore, the present invention is not limited to the above embodiments. The present invention can also be applied to an analysis apparatus that not only uses waveform data regarding a thermal characteristic as a function of temperature or time, but also uses waveform data such as liquid chromatography using waveform data as a function of intensity or time, X-ray fluorescence using waveform data regarding an X-ray characteristic as a function of intensity or energy, and spectroscopic analysis using waveform data regarding an optical characteristic as a function of intensity or wavelength.

What is claimed is:

1. An information processing unit that performs data analysis based on waveform data, the information processing unit comprising:
a processor that executes a computer program;
a storage device that stores a plurality of parameter set candidates related to the computer program;
a display device that displays information received from the computer program to a user; and
an input device that receives, from the user, an input related to setting information regarding a parameter related to the computer program, wherein
the processor receives the waveform data,
the display device displays a plurality of analysis results of the data analysis using, as parameter sets, a plurality of parameter set candidates stored in the storage device,
the input device receives, from the user, a parameter set information input related to the setting information, and
the processor specifies adopted parameter set information based on the parameter set information input.

2. The information processing unit according to claim 1, wherein the processor performs the data analysis based on the waveform data by using the adopted parameter set information.

3. The information processing unit according to claim 2, wherein the waveform data is data regarding a thermal characteristic of differential scanning calorimetry (DSC) of thermal analysis.

4. The information processing unit according to claim 3, wherein the data analysis based on the waveform data regarding the thermal characteristic is thermal analysis of a polymer material.

5. The information processing unit according to claim 3, wherein the data analysis based on the waveform data regarding the thermal characteristic is thermal analysis performed when a physical quantity related to endotherm and exotherm of a material is acquired.

6. The information processing unit according to claim 5, wherein the data analysis based on the waveform data regarding the thermal characteristic is thermal analysis performed by specifying a start time or a start temperature of a phase transition of a material and an end time or an end temperature of the phase transition of the material.

7. The information processing unit according to claim 6, wherein the parameter set candidates include a setting item as to whether or not to specify the start time or the start temperature of the phase transition of the material from an intersection between the waveform data and a tangent of the waveform data at the end time or the end temperature of the phase transition of the material.

8. The information processing unit according to claim 6, wherein the parameter set candidates include a threshold for a change amount of a curvature value of a waveform during a predetermined time section, and in a case where the threshold is exceeded, occurrence of the phase transition is detected by the data analysis based on the waveform data regarding the thermal characteristic using the adopted parameter set information.

9. The information processing unit according to claim 6, wherein the parameter set candidates include a setting item as to whether or not to calculate the start time or the start temperature of the phase transition of the material or the end time or the end temperature of the phase transition of the material by a search using the calculated start time or start temperature and the calculated end time or end temperature as initial values so as not to cause an intersection when a line segment connecting a value at the calculated start time or start temperature and a value at the calculated end time or end temperature of the phase transition of the material for the waveform data intersects the waveform data.

10. The information processing unit according to claim 2, wherein the parameter set information input from the user is an input of information including at least one of information selected from the plurality of parameter set candidates and information for individually changing a value set in the parameter set candidate.

11. The information processing unit according to claim 2, wherein the data analysis using the plurality of parameter set candidates stored in the storage device as the parameter sets and the data analysis based on the waveform data regarding the thermal characteristic using the adopted parameter set information are separate data analyses having different execution speeds.

12. An information processing method for causing an information processing unit that performs data analysis based on waveform data regarding a thermal characteristic to perform the data analysis, the information processing unit including a processor that executes a computer program, a storage device that stores a plurality of parameter set candidates related to the computer program, a display device that displays information received from the computer program to a user, and an input device that receives, from the user, an input for setting information regarding a parameter related to the computer program, the information processing method comprising:
receiving the waveform data regarding the thermal characteristic;
displaying, on the display device, a plurality of thermal analysis results of the data analysis using, as parameter sets, a plurality of parameter set candidates stored in the storage device;
receiving, by the input device, a parameter set information input related to the setting information from the user; and
specifying adopted parameter set information based on the parameter set information input.

13. An analysis apparatus using the information processing unit according to claim 1.

14. The analysis apparatus according to claim 13, wherein the waveform data is data regarding the thermal characteristic.

15. The analysis apparatus according to claim 13, wherein the waveform data is data regarding an X-ray characteristic.

16. The analysis apparatus according to claim 13, wherein the waveform data is data regarding an optical characteristic.

17. The analysis apparatus according to claim 13, wherein the waveform data is data regarding electron beam scattering or an ion characteristic.
